(19) United States
(12) Patent Application Publication
(10) Pub. No.: US 2016/0279838 A1
(43) Pub. Date: Sep. 29, 2016

(54) MOULDING METHOD AND MOULDING MACHINE FOR SOLID AND TUBULAR STRUCTURES

(71) Applicant: CRORME LIMITED, Cheshire (GB)

(72) Inventor: Chesney Richard Orme, Cheshire (GB)

(21) Appl. No.: 14/442,290

(22) PCT Filed: Nov. 12, 2013
(86) PCT No.: PCT/GB2013/000483

§ 371 Date: May 12, 2015

(30) Foreign Application Priority Data
Nov. 12, 2012 (GB) 1220322.0

(51) Int. Cl. B29C 41/04; B29C 41/52; B29C 41/36; B29C 41/46; B29B 17/02; B29B 13/02

(52) U.S. Cl. CPC B29C 41/04; B29B 17/02; B29B 13/022; B29C 41/36; B29C 41/46; B29C 41/52; B29B 2017/0203; B29L 2023/22

(57) ABSTRACT

A method and a mould (101) for making circular section plastics mouldings (105) comprising feeding (18) melted plastics material into a circular section mould (101) rotating (106) about its axis.

This invention relates to moulding machines, more particularly to moulding machines for making circular section structural members such as fence posts.

Particularly when recycling mixed plastics materials into new plastics products by extruding melted plastics into a mould, problems arise that militate against moulding at reasonable rates of production. One problem is that the melted plastic tends to stick to the walls of the mould and incoming material is forced through an increasingly narrow passage. This seriously limits productivity.

One solution to this problem is found in GB2437938, in which a mould has lengthwise reciprocating side walls.

This is not suitable for circular section mouldings.

The present invention provides a method for making circular section mouldings that overcomes this problem and produces mouldings at substantially increased rates of production.

The invention comprises a method for making circular section plastics mouldings comprising feeding melted plastics material into a circular section mould rotating about its axis.

The melted plastics material may, on introduction, be rotated oppositely to the mould.

The melted plastics material may be introduced into the rotating mould from a screw extruder from which it emerges with the opposite hand of rotation to the mould. The extruder may be operated without a breaker plate that straightens out the extrudate.

By the rotation, the tendency of the melted plastics material to adhere to the mould wall is substantially reduced, and the rate of throughput is correspondingly increased.

The rotating mould may be driven in rotation by variable speed drives, which may be controlled in dependence on the density of the plastics material.

The mould may have provision for cooling, which may comprise a water jacket, which may have provision for flowing cooling water around the mould. Or a jacketless mould may be immersed in a water bath.

The invention also comprises a mould for making circular section plastics mouldings comprising a tubular mould and drive means rotating the tubular mould about its axis.

A method and apparatus for moulding plastics materials will now be described with reference to the accompanying drawings, in which:

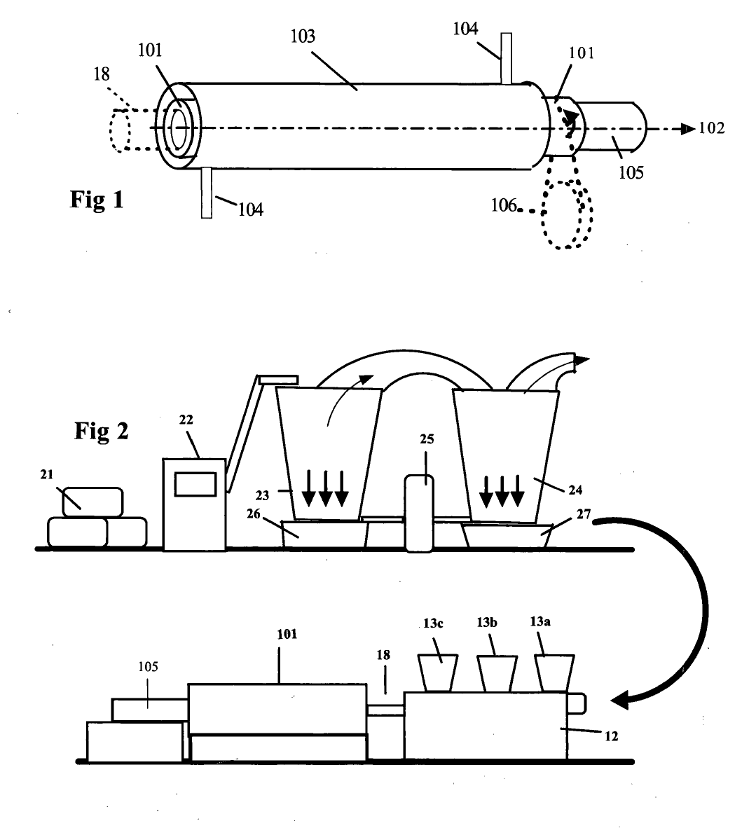

FIG. 1 is a diagrammatic side elevation of one embodiment of apparatus; and

FIG. 2 is a diagrammatic illustration of a plant for granulating, extruding and moulding mixed waste plastics materials incorporating the apparatus of FIG. 1

The drawings illustrate a method for making circular section plastics mouldings comprising feeding melted plastics material into a circular section mould 101 rotating about its axis 102.

The mould 11 is contained in a cooling sleeve 103 through which coolant, for example, water, is passed via inlet and outlet connections 104. Any suitable gland seal arrangement can be used to support the rotating mould 101 in the ends of the sleeve 103.

Melted plastics material is fed in through a feed pipe 18 of an extruder 12, FIG. 2, shown in broken line in FIG. 1.

The mould 101 is rotated by any convenient means—a motor-drive pulley and belt arrangement 106 is shown in broken line. A variable speed drive arrangement can cater for different densities of plastics material.

An important use for a mould as illustrated in FIG. 1 is in a production line for recycling mixed plastics waste, for example mixed plastics separated from municipal waste collections from which other materials such as glass and metals have been separated.

FIG. 2 illustrates the mould 11 in such a production line. Bales 21 of mixed plastics materials, for example from municipal refuse sorting sites, are fed into a granulator 22 and from there to a first separator 23 comprising a chamber in which a blower 25 generates an upward flow of air sufficient to carry less dense granules upwards to flow out and into an adjacent separator 24 in which an upward flow of air is sufficient to effect further separation of the less dense granules from light-weight contaminants. Denser granules fall into skips 26, 27, and are passed on to the extruder 12, where the denser granules from skip 26 are loaded into hopper 13a, lighter granules from skip 27 into hopper 13b. If desired, further granules or particulate or power or fibre fillers and/or a blowing agent may be added through hopper 13c.

Solid extrudate from the extruder 12 flows through feed pipe 18 into the mould 101, from which circular section product 105 is delivered. This can be cut off in desired lengths in a continuous production process.

Instead of a water jacket through which water flows, the mould could be immersed in a water bath.

1. A method for making circular section plastics mouldings comprising feeding melted plastics material into a circular section mould rotating about its axis.

2. A method according to claim 1, in which the melted plastics material is, on introduction, rotated oppositely to the mould.

3. A method according to claim 1, in which the melted plastics material is introduced into the rotating mould from a screw extruder.

4. A method according to claim 4, in which the melted plastics material emerges from the screw extruder with the opposite hand of rotation to the mould.

5. A method according to claim 4, in which the extruder is operated without a breaker plate that straightens out the extrudate.

6. A method according to claim 1, in which the rotating mould is driven in rotation by variable speed drives, which may be controlled in dependence on the density of the plastics material.

7. A method according to claim 1, in which the mould has provision for cooling.

8. A method according to claim 7, in which the provision for cooling comprises a coolant jacket.

9. A method according to claim 8, comprising provision for flowing coolant such as water around the mould.

10. A method according to claim 7, in which a jacketless mould is immersed in a water bath.

11. A mould for making circular section plastics mouldings comprising a tubular mould and drive means rotating the tubular mould about its axis.

12. A mould according to claim 11, connected to a source of melted plastics material rotating in opposite direction to the mould.

13. A mould according to claim 12, in which the source comprises a screw extruder.

14. A mould according to claim 11, immersed in a cooling jacket through which coolant such as water flows.

15. A mould according to claim 11, immersed in a coolant bath.

16. A mould according to claim 11, in a production line for recycling mixed plastics waste, also comprising a granulator and separator means separating granules of mixed plastics into lots having different melt temperatures, and a barrel extruder into which granules with different melt temperatures are introduced at different places along the barrel and feed pipe of the extruder is connected to supply the mould.
